(19) United States
(12) Patent Application Publication
(10) Pub. No.: US 2024/0395428 A1
(43) Pub. Date: Nov. 28, 2024

(54) THORIUM MOLTEN SALT REACTOR USING 100% NON-RADIOACTIVE THORIUM FUEL AND A NUCLEAR POWER GENERATING SYSTEM

(71) Applicant: Kyunam CHOI,, La Mirada, CA (US)

(72) Inventor: Kyunam CHOI,, La Mirada, CA (US)

(21) Appl. No.: 18/201,917

(22) Filed: May 25, 2023

(51) Int. Cl. G21D 3/00; G21C 1/22; G21C 3/54; G21C 7/34; G21D 1/02; G21D 3/10

(52) U.S. Cl. CPC G21D 3/007; G21C 1/22; G21C 3/54; G21C 7/34; G21D 1/02; G21D 3/001; G21D 3/10

(57) ABSTRACT

The present invention is related to a Thorium Molten Salt Reactor (Th-MSR) using 100% non-radioactive Thorium fuel, composed of LiF+BeF₂+ThF₄ without containing any U-235. The Th-MSR is consisted of a reactor chamber, a fuel injector, a fuel reservoir, an in-line chemical extraction unit, a heat exchanger, a few KW electricity turbine generator and a condenser. A few KW nuclear power generation system is adopting the controlling devices comprised of a neutron flux sensor, a fuel injecting sensor, a thermal sensor and a power output sensor. A neutron generator with a high neutron flux of 10¹³ n/s is used. The high flux fast neutrons are slowing down into the thermal neutrons by the graphite moderators in the reactor for initiating the fission.

This is a Continuation in Part (CIP) of Ser. No. 17/026,229 filed Sep. 20, 2020, now pending U.S. patent application.

### BACKGROUND OF THE INVENTION

### 1. Field of the Invention

The present invention relates to a Thorium Molten Salt Reactor (Th-MSR) using 100% non-radioactive Thorium fuel and a nuclear power generating system. More particularly, it is concerned a few KW Nuclear Power Generating System utilizing a Thorium Molten Salt Reactor (Th-MSR) using 100% Non-radioactive Thorium Fuel and employing a plurality of Neutron Generators. Therefore, the present Thorium Molten Salt Reactor won't require any radioactive material mixed with the Thorium fuel.

### 2. Related Prior Art

Generally known as that, an Alvin Weinberg's team at ORNL has developed a Thorium Molten Salt Reactor (Th-MSR), which has kept producing 8 MW (thermal) output power, in 1965 until 1969. FIG. 4 shows a conventional Thorium Molten Salt Reactor chamber developed by Alvin Weinberg's team at ORNL. The conventional Thorium Molten Salt Reactor is consisted of a reactor cover (10), a reactor vessel (11), control rods (12), a graphite reflector (13), a moderator (14), a reflector retainer (15), and a clearance space (16).

Subsequently, the ORNL team has developed an advanced Thorium Molten Salt Reactor (Tr-MSR) fuel with LiF—BeF₂—(Th, U)F₄, which is mixed ThF₄ with UF₄ in the ratio of 80% to 20%. The thermal neutrons required to sustain the Thorium fuel cycle could be obtained by slowing down the fast neutrons from the natural decay of the Uranium-235 in UF₄ by making them to undergo multiple collisions with C-14 atoms in graphite moderators in the reactor. In the FIG. 4, a schematic drawing of Thorium MS Reactor chamber designed by ORNL in 1969 illustrates multiple of the fuel tubes, the graphite moderators and the graphite reflectors. The ORNL's Thorium MSR of 1969, a reactor chamber has a dimension of 18 ftϕ×18 ftH. The Th-MSR program of ORNL was terminated by Nixon Administration in 1970 and classified as a secret until 2005.

In addition, the Thorium fuel cycle is developed in the following order; that is, when a thermal neutron collides to a Thorium-232 atom, the Thorium-232 atom converts into a Thorium-233 atom. The Th-233 has a half-life of 22 minutes and it transforms into a Protactinum-233 after beta decay. The Protactinum-233 has a half-life of 27 days and it transforms into a Uranium-233 after beta decay. When a Uranium-233 collides with a thermal neutron, it causes nuclear fission. The U-233 atom splits into two atoms forming similar size while fission energy of 198 MeV is generated and create two fast neutrons.

In other words, it takes about a month to complete the Thorium fuel cycle from a fresh Th-232 atom to transform into a U-233 atom. When a U-233 starts fission, two neutrons and 198 MeV (=3.1723×10⁻¹¹ Joule) energy would be released. Therefore, the number of U-233 atoms required to produce one Watt electricity is 3.1522×10¹⁰ atoms per second. Hence, for producing one KW of electricity, at least 3.1522×10¹³ Thermal neutrons should be transmitted to the Thorium fuel per second. (Ref.: 1 Joule is 1 Watt-sec.)

For example, a U.S. Pat. No. 6,907,097 in 2002, which is regarding to the neutron generator IB-1764, the Berkley Lab Technology of U.C. Berkley has disclosed RF-driven plasma ion source and a cylindrical titanium target. A neutron generator for example IB-1764, can produce a very high neutron flux of approximately 1×10¹³ n/s with 2.2 MeV energy through D-D (deuterium) reaction, and approximately 1×10¹⁵ neutrons per second in case of D-T (tritium) reaction. FIG. 5 is a Cylindrical Neutron Generator using as a neutron source for initiating fission.

By using a Neutron Generator with nested design or by incorporating several Neutron Generators inside a Th-MSR chamber, it is possible to emit the thermal neutron flux of approximately 3×10¹³ n/s into the Thorium fuel in the reactor and obtain approximately one KW power output. FIG. 4 shows a conventional Thorium Molten Salt Reactor chamber adopted multiple Neutron Generators of IB-1764s, which is capable to produce one KW electricity.

After the secret was lifted in 2005, research for Th-MSR was carried out at the many research centers around the world including Belgium, Brazil, China, Canada, Germany, Norway, the Netherlands, India, Japan, Russia, the UK and the US. For each case of research, Uranium-235 in the form of UF₄ was mixed into the Th-MSR fuel to provide neutrons.

Subsequently, all the Th-MSR research performed world-widely have relied on neutrons generated by fission of U-235 atoms.

Consequently, the purpose of present invention is to use an advanced neutron generator as a neutron source and a flux sensor for monitoring the flux amount of the neutron while using 100% non-radioactive Thorium Molten Salt fuel without containing any U-235 material in the Th-MSR fuel.

### SUMMARY OF THE INVENTION

Accordingly, the present invention discloses a Thorium Molten Salt Reactor (Th-MSR) using 100% non-radioactive Thorium fuel.

Further, the present invention discloses a process of producing nuclear energy by emitting the thermal neutrons to Thorium MSR fuel, which is composed of LiF+BeF₂+ThF₄ with a Mole % of 72:16:12 and the Thorium fuel flows at a temperature of 566° C. into the fuel tubes. When a thermal neutron collides to U-233 atom in the reactor, fission takes place and hence, nuclear power is produced.

More specifically, a Thorium fuel cycle is explained as follows; when a thermal neutron collides to a Th-232, it will transform to a Th-233 and subsequently convert to a Pa-233 with the beta decay. The Protactinum-233 has a half-life of 27 days and it transforms into a Uranium-233 after beta decay. When a U-233 atom absorbs a thermal neutron, it will break out into either one of (1) Ba-141 and Kr-92, (2) Ba-140 and Kr-93 or (3) Ba-142 and Kr-91. At the same time, fission takes place to release the nuclear energy, and emitting two neutrons. It will take about a month to complete the Thorium fuel cycle from a fresh Th-232 atom to transform into a U-233 atom.

$${n}^{neutron} + {}_{90}^{232} Th ⟶ {}_{90}^{233} Th {⟶}^{{β}^{-}} {}_{91}^{233} Pa {⟶}^{{β}^{-}} {{}_{92}^{233} U}^{fuel}$$

According to the present invention, the Thorium Molten Salt fuel injected into the reactor tube at a temperature of 566° C. is heated up to 704° C. due to nuclear fission of U-233 by colliding with thermal neutrons emitted from the neutron generators. Then, the nuclear energies are released out and flow thru a heat exchanger for producing hot steam to operate the turbine generator. Hot steam produced from the heat exchanger enters into the few KW electricity turbine generator to produce electrical power and returns to the heat exchanger thru a condenser. The returned steam is cooled down to 566° C. FIG. 1 shows the schematic diagram of the nuclear power generating system with a Thorium Molten Salt Reactor equipped with the multiple neutron generators.

The output power of this Thorium Molten Salt Reactor is proportional to the number of thermal neutrons absorbed by the molten salt fuel in the reactor. It is possible to control the nuclear power output by adjusting the RF excitation voltage supplied to the Neutron Generators. It is also possible to turn on and off the nuclear power generation by turning on and off the Neutron Generators.

Further, it is possible to stop the fission process in the Thorium Molten Salt Reactor automatically, if the temperature of the Thorium Reactor is increased over a certain limitation (e.g., 870° C.). Due to the expanded molecular distance, the nuclear fission is prohibited, spontaneously. Therefore, the power generating system will be shut down automatically and the thermal runaway will never take place. Also, there is no risk of explosion since the whole nuclear power generating system operates under 1 atmospheric pressure.

Hereby, the present invention of the Nuclear Power Generation System e.g., a Thorium Molten Salt Reactor adopted the Neutron Generators would be one of the most innovative nuclear power producing device to generate a few KW electricity applying currently developed technologies and without containing any radioactive material, such as U-235. As shown in FIG. 1, a nuclear power generating system is comprised of: a Thorium reactor chamber (200) with a plurality of fuel tubes (201), a plurality of graphite moderators (202), a plurality of neutron generators (204) and a graphite reflector (203); a fresh fuel injector (300) which is for injecting Thorium fuel into the fuel tubes (201); a fuel Reservoir (310) which is for storing and readying to inject the Thorium fuel; wherein, the Thorium fuel is the 100% non-radioactive material, which is composed of LiF+BeF₂+ThF₄ without containing any U-235 material; an in-line chemical Extraction unit (320) is for filtering out a radioisotope, such as fission residue formed inside the Thorium fuel after fission; a heat exchanger (400) is for heating up a steam thru heat exchanging process with Thorium fuel fission, and a hot steam inlet to a few KW electricity turbine generator (500); the few KW electricity turbine generator (500) is for producing electricity based on demanding power; and a condenser (600) is for collecting the retuned steam from the few KW electricity turbine generator (500).

In addition to the above objects, the advantages and other objects of the present invention will be apparently revealed through the detailed description of the embodiments with reference to the accompanying drawings.

### BRIEF DESCRIPTION OF THE DRAWINGS

FIG. 1 is the present invention of a Thorium Molten Salt Reactor using 100% non-radioactive Thorium fuel and a nuclear power generating system.

FIG. 2 is a sectional views A-A of the Thorium Molten Salt Reactor chamber, illustrating a plurality of the fuel tubes, graphite moderators, neutron generators and a graphite reflector.

FIG. 3 is the present invention showing a schematic Diagram of the nuclear power generating system and operating control system of the Thorium Molten Salt Reactor including a Neutron flux sensor, a fuel injecting sensor, a thermal sensor and a power output sensor.

FIG. 4 is the conventional Thorium Molten Salt Reactor chamber developed by Alvin Weinberg's team at ORNL.

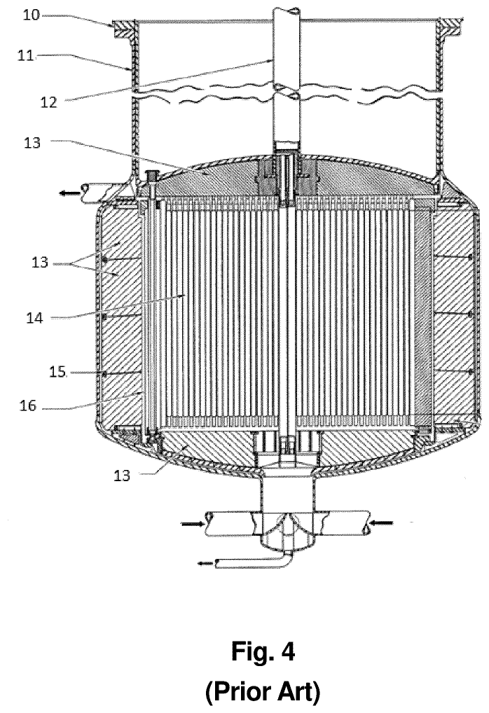

FIG. 5 is a conventional Neutron Generator for emitting the Neutron fluxes to the Thorium fuel in the Reactor fuel tube.

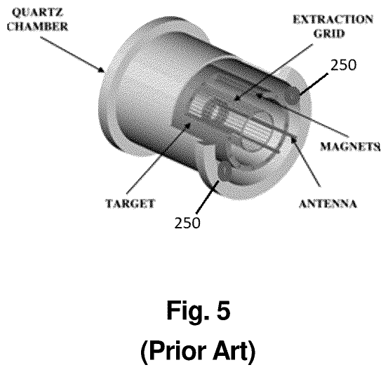

### DETAILED DESCRIPTION OF THE PREFERRED EMBODIMENTS

Hereinafter, the present invention of a Thorium Molten Salt Reactor using 100% non-radioactive Thorium fuel and a nuclear power generating system will be described in detail with reference to the accompanying drawings.

First of all, it should be aware that the same component or same part in the figures, an identical reference numeral is used as possible to represent. Also, it should be noted that the detailed descriptions, which are related to the known functions or components will be omitted in order to unambiguous the gist of present invention.

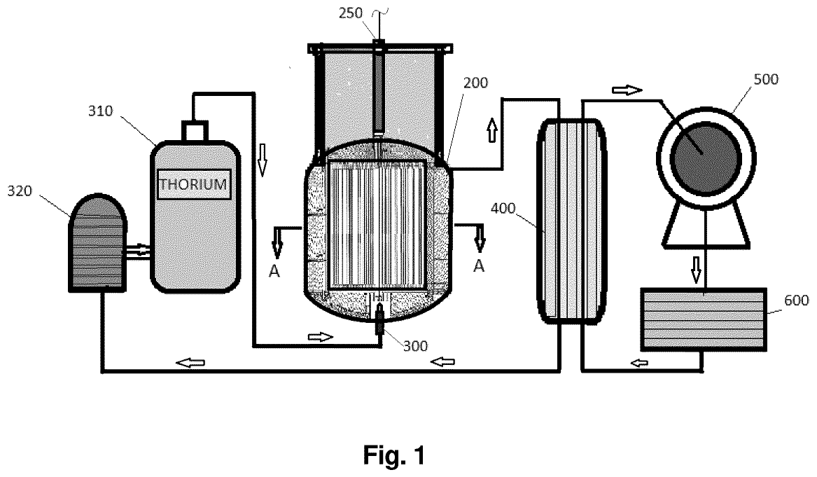

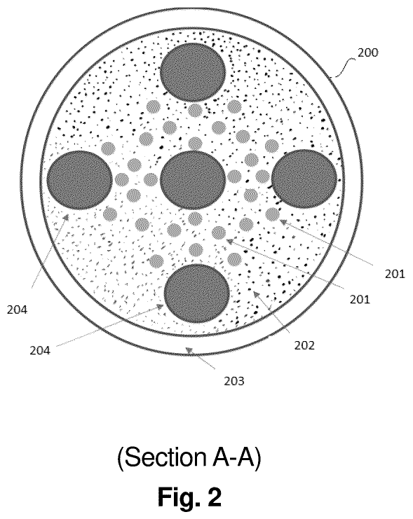

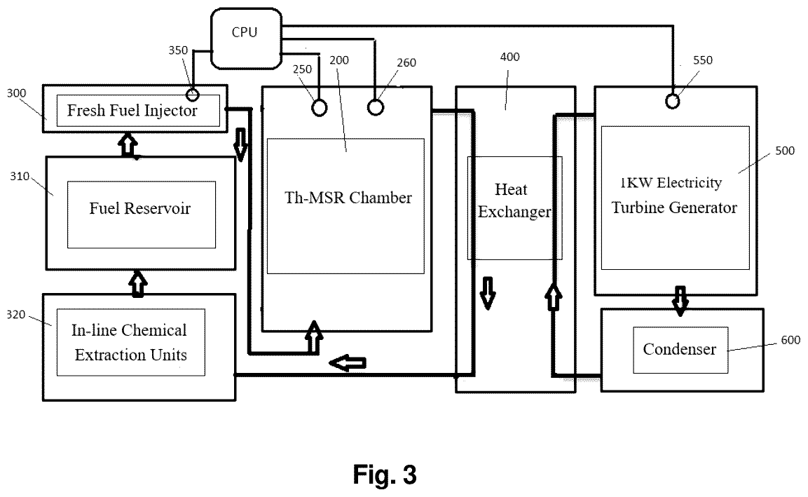

FIG. 1 shows the present invention of a Thorium Molten Salt Reactor using 100% non-radioactive Thorium fuel excluding U-235, and a nuclear power generating system. FIG. 2 is a cross sectional views A-A of the Thorium Molten Salt Reactor chamber illustrating the multiple fuel tubes, the graphite moderators, the multiple neutron generators and a reflector. FIG. 3 is a schematic diagram of the nuclear power generating system and operation control system of the Thorium Molten Salt Reactor including a neutron flux sensor, a fuel injecting sensor, a thermal sensor and a power output sensor.

According to the present invention shown in FIG. 1, the Thorium Molten Salt Reactor (Th-MSR) using 100% non-radioactive Thorium fuel and a nuclear power generating system is comprised of: a Thorium reactor chamber (200) is consisted of a plurality of fuel tubes (201); a plurality of graphite moderators (202); a plurality of neutron generators (204); and a graphite reflector (203); a fresh fuel injector (300) is for injecting Thorium fuel into the fuel tubes (201); a fuel Reservoir (310) is for storing and readying to inject the Thorium fuel; wherein, the Thorium fuel is 100% non-radioactive material, and is composed of LiF+BeF₂+ThF₄; an in-line chemical Extraction unit (320) is for filtering out a radioisotope, such as a fission residue from returned Thorium fuel after fission; a heat exchanger (400) is for producing a hot steam thru heat exchanging process with the Thorium fuel fission, and the hot steam flows inlet to a few KW electricity turbine generator (500); the few KW electricity turbine generator (500) is for producing electricity based on the power demanding; and a condenser (600) is for collecting the retuned hot steam from the few KW electricity turbine generator (500).

Furthermore, the Thorium fuel is mixed with a composition ratio of 72 mol % ₇LiF, 16 mol % BeF₂, 12 mol % ThF₄, which are 100% non-radioactive materials excluding any uranium material U-235.

Further, the reactor chamber of Thorium Molten Salt Reactor is formed a cylindrical shape with dimension of 4 ftϕ×4 ftH for a smart size. Depending on the required power capacity, a various size of reactor chambers can be manufactured having different dimensions of diameter and height.

Further, the reactor chamber (200) of Thorium Molten Salt Reactor (Th-MSR) is comprised of: a plurality of neutron generators (204) as neutron sources with a cylindrical shape;

Additionally, the nuclear power generating system of Thorium Molten Salt Reactor has equipped with an operating control system consisted of: a neutron flux sensor (250) is for controlling the flux amount of the neutrons emitted to the Thorium fuel in the fuel tubes (201); wherein, a CPU (150) performs a calculation to determine a required amount of the neutron flux based on a required power, and sends a control signal to RF excitation voltage generator for the neutron generators (204) for adjusting the neutron flux; a fuel injecting sensor (350) is for controlling an amount of the Thorium fuel injected into the fuel tubes (201); wherein, the CPU (150) performs a calculation to determine a required amount of the Thorium fuel based on a received signal of the neutron flux sensor (250), and sends a control signal to activate the fuel injecting sensor (350) for adjusting the Thorium fuel injection: a thermal sensor (260) is for monitoring temperature of the Thorium reactor chamber (200) for maintaining the chamber temperature within operable range, and a power output sensor (550) is for monitoring the power output from the few KW electricity turbine generator (500) depending on the power demand.

Furthermore, it is possible to monitor the CPU and operating system via a remote control, such as an operator's cell phone.

However, the present invention provides a process of obtaining nuclear energy by introducing thermal neutrons to Thorium fuel loaded inside of fuel tubes in the Thorium Molten Salt Reactor (Th-MSR) chamber, in which Thorium fuel composed of LiF+BeF₂+ThF₄ with a Mole % of 72:16:12 flows at a temperature of 566° C. When the thermal neutrons collide with U-233 atoms in the reactor, fission takes place, and hence, nuclear power is produced.

Accordingly, the Thorium molten salt fuel, which enters into the reactor at a temperature of 566° C., is rising up to 704° C. due to nuclear fission of U-233. The fission takes place by thermal neutrons emitted from the neutron generator. Then, the hot Thorium fuel underwent fission flows into a heat exchanger to produce a hot steam via heat exchanging process for operating the turbine generator. The Thorium fuel is cooled down to the temperature of 566° C. and returned back to the reactor via an in-line chemical extraction unit (320). The hot steam, which is produced thru the heat exchanging process with the Thorium fuel fission, enters into the few KW electricity turbine generator for producing the electrical power and returns back to the heat exchanger via a condenser. Referring to the FIG. 1, one can easily understand the process of the nuclear power generating system for a Thorium Molten Salt Reactor.

More specifically, a Thorium fuel cycle is explained as follows; when a thermal neutron collides to a Th-232, it will transform to a Th-233, and subsequently convert to a Pa 233 with the beta decay. After a half-life of 27 days, it will convert to a U-233 with the beta decay and sequentially, after absorbing a thermal neutron, it will break to either one of (1) Ba-141 and Kr-92, (2) Ba-140 and Kr-93 or (3) Ba-142 and Kr-91. When fission takes place to release the nuclear energy, two neutrons are generated. It will take about a month to complete the Thorium fuel cycle from a fresh Th-232 atom to transform into a U-233 atom.

$${n}^{neutron} + {}_{90}^{232} Th ⟶ {}_{90}^{233} Th {⟶}^{{β}^{-}} {}_{91}^{233} Pa {⟶}^{{β}^{-}} {{}_{92}^{233} U}^{fuel}$$

In fact that, the nuclear power output of this Thorium reactor is proportional to the number of thermal neutrons supplied to the molten salt fuel in the reactor. The nuclear power output can be controlled by adjusting the RF excitation voltage supplied to the neutron generator.

Furthermore, the fission process in the Thorium Molten Salt Reactor chamber is automatically stopped, if the temperature of the Thorium Molten Salt fuel is raised up to a certain limit. (e.g., temperature of 870° C.) Due to the expansion of molecular distance, the nuclear fission would be terminated, spontaneously. Therefore, the nuclear power generating system will be shut down due to the decay of the thermal neutrons. Therefore, there is no risk of explosion, because the whole nuclear power generating system operates under one atmospheric pressure.

Accordingly, the present invention of a Thorium Molten Salt Reactor adopted a plurality of the neutron generators and the Nuclear Power Generation System will be one of the most innovative power generating system. One can realize that the development of a few KW nuclear power generation system in compact size would not be easy task.

Although the preferred embodiment of the present invention has been disclosed for illustrative purposes, those skilled in the art will appreciate that various modifications, additions and substitutions are possible, without departing from the scope and spirit of the invention as disclosed in the accompanying claims.

What is claimed is:

1. A Thorium Molten Salt Reactor (Th-MSR) using 100% non-radioactive Thorium fuel and a nuclear power generating system are comprised of:
a Thorium reactor chamber (200) with a plurality of fuel tubes (201), a plurality of graphite moderators (202), a plurality of neutron generators (204) and a graphite reflector (203),
a fuel injector (300) is for injecting Thorium fuel into the fuel tubes (201),
a fuel Reservoir (310) is for storing and readying to inject the Thorium fuel, wherein, the Thorium fuel is the 100% non-radioactive material, which is composed of LiF+BeF₂+ThF₄ without containing any U-235 material,
an in-line chemical Extraction unit (320) is for filtering out a radioisotope, such as fission residue from returned Thorium fuel after fission,
a heat exchanger (400) is for producing a hot steam thru heat exchanging process with the Thorium fuel undergone fission, and the hot steam inlet to a few KW electricity turbine generator (500),
the few KW electricity turbine generator (500) is for producing electricity based on demanding power, and
a condenser (600) is for collecting the retuned hot steam from the few KW electricity turbine generator (500).

2. The Thorium Molten Salt Reactor according to claim 1, the Thorium fuel is further comprised of:
the Thorium fuel is mixed with a composition ratio of 72 mol % ₇LiF, 16 mol % BeF₂, 12 mol % ThF₄, which are 100% non-radioactive materials excluding any U-235 material.

3. The Thorium Molten Salt Reactor according to claim 1, the reactor chamber is further comprised of:
the reactor chamber forms a cylindrical shape with a dimension of 4 ftϕ×4 ftH for a smart size, and a various size of reactor chambers can be manufactured having different dimensions of diameter and height according to required power demand.

4. The Thorium Molten Salt Reactor according to claim 1, the Th-MSR chamber is further comprised of:
a plurality of neutron generators (204) as neutron sources in cylindrical shape.

5. The Thorium Molten Salt Reactor according to claim 1, the nuclear power generating system is further comprised of:
a neutron flux sensor (250) is for controlling the flux amount of the neutrons emitted to the Thorium fuel in the fuel tubes (201),
wherein, a CPU (150) performs a calculation to determine a required amount of the neutron flux based on a required power, and sends a control signal to RF excitation voltage generator for the neutron generators (204) for adjusting the neutron flux,
a fuel injecting sensor (350) is for controlling an amount of the Thorium fuel injected into the fuel tubes (201),
wherein, the CPU (150) performs a calculation to determine a required amount of the Thorium fuel based on a received signal of the neutron flux sensor (250), and sends a control signal to activate the fuel injecting sensor (350) for adjusting the Thorium fuel injection,
a thermal sensor (260) is for monitoring temperature of the Thorium reactor chamber (200) for maintaining the chamber temperature within operable range, and
a power output sensor (550) is for monitoring the power output from the few KW electricity turbine generator (500) depending on the power demand.
